(19) United States
(12) Patent Application Publication
(10) Pub. No.: US 2021/0235907 A1
(43) Pub. Date: Aug. 5, 2021

(54) DISPENSING AND MIXING DEVICE

(71) Applicants: Renata BAION, Castelfranco Veneto (TV) (IT); Barbara BERTI, Marcon (VE) (IT); Mauro ARGENTI, Castelfranco Veneto (TV) (IT); Vittorio AMADIO, Trebaseleghe (PD) (IT)

(72) Inventors: Mauro ARGENTI, Castelfranco Veneto (IT); Gianluca BARNABA, Castelfranco Veneto (IT)

(73) Assignees: Renata BAION, Castelfranco Veneto (TV) (IT); Barbara BERTI, Marcon (VE) (IT); Mauro ARGENTI, Castelfranco Veneto (TV) (IT); Vittorio AMADIO, Trebaseleghe (PD) (IT)

(21) Appl. No.: 17/048,933

(22) PCT Filed: Apr. 15, 2019
(86) PCT No.: PCT/IB2019/053072

§ 371 Date: Oct. 19, 2020

(30) Foreign Application Priority Data
Apr. 17, 2018 (IT) 202018000002394

(51) Int. Cl. A47G 21/04; A61J 7/00

(52) U.S. Cl. CPC A47G 21/04; A61J 7/0023

(57) ABSTRACT

A dispensing and mixing device including at least a functional portion, a handle that defines a cavity containing a substance adapted to be administered by the dispensing and mixing device by the opening of a flap, wherein the handle includes a grooved portion and a lid adapted to overlap and engage mechanically with each other to operatively define the closed cavity, and moreover, the flap is elastically deformable and adapted to alternately open the cavity when it is urged and to close the cavity when it is not urged.

### TECHNICAL FIELD OF INVENTION

The present invention refers to a dispensing and mixing device having the function of holding, administering and mixing, that is distributing, a substance for preferably alimentary or pharmaceutical use.

### BACKGROUND OF THE INVENTION

Spoons and other utensils adapted for mixing a substance in a liquid for alimentary uses, such as for example sugar in a beverage. or for pharmaceutical uses, such as for example a medicinal drug in water, are well known in the state of the art. Further, the substance to mix is generally held in appropriate containers, such as for example small envelopes where it is kept before its use.

In various fields, such as for example in the food service field, or in the pharmaceutical field, there is the necessity of administering the substance and mixing it in a liquid by carrying out a limited number of operations, arranging, when administering it, both the substance and the utensil necessary for appropriately mixing the liquid.

The state of the art includes solutions for administering and mixing a preset quantity of substance, such as an alimentary product such as sugar or a medicine, so as to make it easier to use the substance and avoid having to use separate articles, such as the envelope and the mixing device.

In the document IT0000281412 is described a dispensing container, having the shape of a cutlery, adapted for integrating the function of dispensing a substance, contained in a cavity provided in the handle, with the function of cutlery.

This dispensing container having the function of cutlery has, however, some drawbacks which will be described below.

In fact, this container with the function of cutlery contains a preset dose of substance which, when it is being used, is supplied in the entire lot and, therefore, it is not possible to suitably supply, that is adjust, the quantity desired by the user, as it is not possible to close the cavity containing the substance once this cavity has been opened.

For example, if a substance such as sugar is to be mixed in the coffee, different users may desire different quantities of sugar and, therefore, it is necessary to be able to deliver the entire dose of sugar, or else only one portion of this amount, depending on the need of the user.

Similarly, in the pharmaceutical field the same medicine can be administered in different amounts, depending on the user, such as for example an adult or a child, and/or the dose can be given at different moments, such as for example ½ dose two times a day.

Further, during the phase of production of the dispensing container functioning as cutlery described in the document IT0000281412 it is necessary to first fill the cavity designed to hold the substance to deliver and, afterward, to close the same cavity using methods such as, generally, hot sealing.

This last step provides drawbacks since the procedure required to perform the hot sealing requires the use of high temperatures, to seal the walls that define the cavity, which alter the characteristics of the substance contained in the cavity and, consequently, reduce its quality and/or effectiveness. For example, in the case of sugar, the high temperatures induce a process of caramelization with a consequent change of appearance and flavour, while for medicinal drugs the excessive temperatures may induce, depending on the type of drug, their degradation and harm their effectiveness or, in the worst case, may make them harmful due to the formation of degraded products.

Finally, the dispensing container functioning as cutlery described in document IT0000281412, because of its shape, is not easy to produce and assemble using the conventional processes.

The present invention refers to a dispensing and mixing device that is an improvement of the dispensing container described in the utility model IT0000281412.

### SUMMARY OF THE INVENTION

The objective of the present invention is to provide a dispensing and mixing device, preferably for alimentary or pharmaceutical uses, that makes it possible to adjust the quantity of substance supplied, that guarantees during its assembling phase the maintenance of the characteristics of the substance contained, and that is simple to produce.

In the scope of the above objective, a purpose of the present invention concerns the production of a dispensing and mixing device formed so as to include a cavity for containing the substance to be supplied which, operatively, can be opened and closed by the user in an effective, simple and intuitive manner so as to allow the administration of the substance contained therein.

A further objective concerns the production of a dispensing and mixing device which in the assembling phase does not require hot sealing steps for closing and defining the cavity that contains the substance to be administered.

A further objective concerns the production of a dispensing and mixing device formed by elements that are easily assembled, that can be realized in a simple manner using conventional processes, and whose production is therefore simplified with respect to the prior art.

The above task and objectives, and others that will be more evident in the description which follows, are achieved by a dispensing and mixing device as defined in claim 1.

### BRIEF DESCRIPTION OF THE FIGURES

The further characteristics and advantages of the dispensing and mixing device of the present invention will become more evident from the following description relative to a preferred embodiment given purely by way of example, without limitations, with reference to the following figures, in which:

FIG. 1 is a perspective view of a dispensing and mixing device according to a preferred embodiment of the present invention;

FIG. 2 is a view from above of the dispensing and mixing device of FIG. 1;

FIG. 3 is a side view of the dispensing and mixing device of FIG. 1;

FIG. 4A is a cross sectional view of the dispensing and mixing device along line B-B of FIG. 2;

FIG. 4B is a cross sectional view of the dispensing and mixing device along line A-A of FIG. 2;

FIGS. 5A to 5D are schematic perspective views that illustrate step-by-step the assembling steps of the dispensing and mixing device of FIG. 1.

### DETAILED DESCRIPTION OF THE INVENTION

The present invention refers to a dispensing and mixing device adapted to administer a solid substance in powder or granular form, preferably such as a food product like sugar, and also adapted for mixing this substance in a liquid, such as preferably an alimentary product like a beverage, so as to enable its complete solubilisation or its homogeneous distribution within the liquid or on the surface of a food product. In this preferred embodiment, the dispensing and mixing device will have the shape and function of cutlery, such as for example a spoon, to be used in the foodstuffs field.

This preferred embodiment however cannot in any way be considered as a limitation of the field of application of the present invention as it can be applied for the production of any device adapted for mixing a substance in powder or granular form, like a food product such as sugar, salt, condiments, etc., or a pharmaceutical compound or composition, within a liquid of adapted viscosity, such as a beverage or a pharmaceutically acceptable vehicle. Alternatively, it is possible to provide a device adapted for dispensing the substance on the surface of a food product or, in the case of a medicinal drug, on a surface to be treated.

Further, the dispensing and mixing device can have any further shape and function adapted for mixing, or apportioning, the substance, such as for example in the shape of a rod, spatula or the like.

In the description which follows the term “substance” refers to a product, preferably solid, provided in powder or granular form, which to be properly administered is added and mixed in a liquid, or spread on the surface of a food product or on a surface to be treated.

Finally, in the description which follows the terms “elastically deformable”, “elastic deformation” and “elastic spring-back” will refer to the property of an element of the dispensing and mixing device, and of its constituent material, to deform by the effect of a mechanical strain, preferably applied with a pressure of the fingers of the hand, and to recover the original shape, that is, to return to the natural configuration at the end of the mechanical strain.

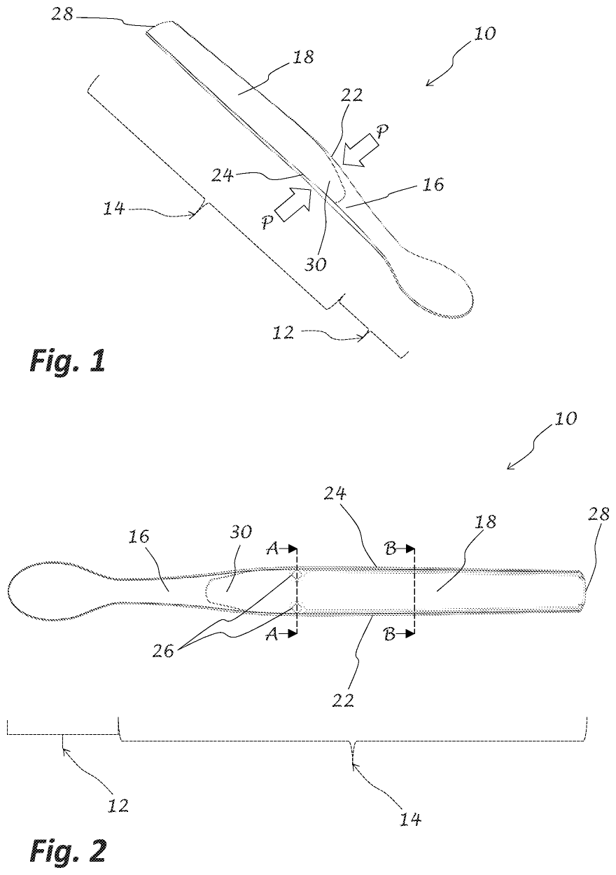

With reference to FIG. 1, the dispensing and mixing device 10 comprises a functional portion 12 and a handle 14 having an elongate and hollow body. Specifically, the functional portion 12 is connected to the handle 14 through a first end of the latter.

In the preferred embodiment of the present invention, the functional portion 12 is made so as to have a spoon shape, however it can have any shape suitable for using the dispensing and mixing device, such as for example a fork, knife, rod, spatula and the like.

With reference to FIGS. 1, 2, 3, 4A and 4B, the handle 14 is provided in turn with a grooved portion 16 and a lid 18 adapted to engage each other to form and define a closed cavity 20 in which is contained the substance, such as for example sugar, to be administered by using the dispensing and mixing device 10.

Specifically, the grooved portion 16 has preferably a substantially U-shaped cross section having plane or rounded side walls and, eventually, having a shape that varies continually along the longitudinal axis of the handle 14, from the functional portion 12 to a second end of the handle 14. Furthermore, the grooved portion 16 is provided with a first side wall 22 and a second side wall 24 on which are formed interference-fit restraining means 26 (see FIGS. 2, 3 and 4B, in which there are two restraining means 26).

In this preferred embodiment, with reference to FIGS. 2, 3 and 4B, the interference-fit restraining means 26 each consist of a pin formed on the lid 18 and a respective seat formed on the grooved portion 16 that are adapted to mutually engage to fasten by interference. In addition, referring to FIG. 4A, on the upper edge of the first side wall 22 and of the second side wall 24 are formed channels adapted to be engaged by respective projections formed on the edges of the lid 18, when the cavity 20 is closed.

Finally, the handle 14 is provided, at its second end, with a hinge 28 that connects the grooved portion 16 to the lid 18. Specifically, the hinge 28 is preferably formed by a connecting edge between the lid 18 and the grooved portion 16 and the thickness of which is adjusted so as to allow the lid 18 to rotate around the connecting edge. In other words, in this embodiment, the hinge 28 is folding line corresponding to a weakened section of the part that connects the lid 18 to the grooved portion 16.

Advantageously the grooved portion 16 and the lid 18 are made as a single piece, adapted to fold over itself by rotating around the hinge 28, making it simple to produce these elements with a single moulding process, however it is possible to provide that the grooved portion 16 and the lid 18 are first made as separate elements that are subsequently joined to each other by conventional joining techniques, such as for example welding processes.

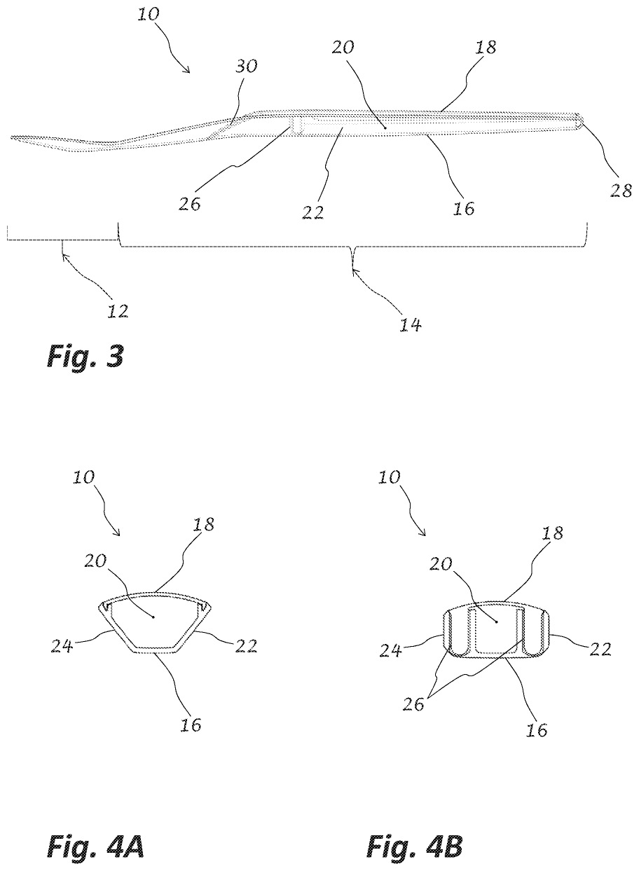

With reference to FIGS. 2 and 3, the lid 18 is formed so that, by rotating around the hinge 28, it can fittingly engage one part of the opening of the grooved portion 16 and fasten itself to the latter through the interference-fit restraining means 26 provided on the first side wall 22 and on the second side wall 24.

In this condition is thus defined the cavity 20 adapted to contain inside the handle 14 of the dispensing and mixing device 10 a quantity of the substance to be dispensed.

Referring again to FIGS. 1, 2 and 3, the lid 18 is provided, at the end opposite the hinge 28, with a lifting flap 30, shaped like a fingernail, inclined with respect to the surface of the lid 18 so that, when the lid 18 engages the upper opening of the grooved portion 16, the peripheral edge of the flap 30, having a shape that is substantially complementary to the cross section of the grooved portion 16, abuts entirely against the internal surface of the grooved portion 16. In this manner, the peripheral edge of the flap 30 is simultaneously in contact with the internal surface of the bottom of the grooved portion 16, with the internal surface of the first side wall 22 and with the internal surface of the second side wall 24.

In other words, the internal surface of the grooved portion 16 and the entire extension of the peripheral edge of the flap 30 are in a contact relationship with a sort of shape coupling when the lid 18 engages the upper opening of the grooved portion 16, so as to define the cavity 20 and close it with respect to the external space, to thus contain and hold the dose of the substance until the moment when flap 30 is lifted, as will be explained later.

Specifically, the flap 30 extends from the end of the lid 18 opposite the hinge 28 and is inclined, with respect to the surface of the lid 18, toward the bottom of the grooved portion 16 so that, when the cavity 20 is closed, the free end of the flap 30 is preferably facing the functional portion 12.

Referring again to FIG. 1, when a pressure is exerted with the fingers on the flap 30 through the first side wall 22 and the second side wall 24, such as to bring the two walls closer to each other, their elastic deformation causes the elastic deformation of the flap 30, thus causing it to lift and allowing the cavity 20 to open toward the external space and, therefore, enabling the delivery of the substance when the dispensing and mixing device 10 is inclined.

In fact, when the first side wall 22 and the second side wall 24 are deformed elastically and brought closer to each other, the peripheral edge of the flap 30 slides on the inside surface of the grooved portion 16 and lifts up.

In other words, referring again to FIG. 1, the pressure applied on the first side wall 22 and on the second side wall 24, represented by the thick arrows shown with the letters “P”, urges the lifting of the flap 30 and partially interrupts the contact relationship between the internal surface of the grooved portion 16 and the entire extension of the peripheral edge of the flap 30 so as to form an opening in the cavity 20 toward the external space.

Advantageously, the extension of the opening of the cavity 20, that is, the degree of lifting of the flap 30, depends on the pressure applied on the first side wall 22 and on the second side wall 24, so that the user, during the supply can easily adjust in a gradual manner the quantity of substance that is supplied from the cavity 20 by simply modulating the pressure that is applied by the fingers and varying the inclination of the dispensing and mixing device 10. Specifically, in an advantageous manner, in the preferred embodiment the first side wall 22 and the second side wall 24 are symmetrical with respect to a longitudinal plane of the handle 14 and are shaped at least partially convergent toward the bottom of the grooved portion 16. In this configuration, when the pressure is exerted on the first side wall 22 and on the second side wall 24, the lifting of the flap 30 is eased by deformation, and the flap 30 is thus prevented from lowering. The lifting is also further eased by a possible rounded shape of the peripheral flap 30 and by the fact that the latter is inclined with respect to the lid 18 from which it extends.

At the end of the pressure exercised, thanks to the spring-back properties of the material which makes up the first side wall 22, the second side wall 24 and the flap 30, these elements are returned to their natural position so as to close the cavity 20 again and re-establishing the contact relationship between the internal surface of the grooved portion 16 and the entire extension of the peripheral edge of the flap 30.

Advantageously, the interference-fit restraining means 26 make it possible to fasten the lid 18 to the grooved portion 16 during a phase of filling the cavity 20 with a quantity of substance, before the user uses the dispensing and mixing device 10, and, at the same time make it possible to keep the lid 18 and the grooved portion 16 fastened to each other even when the pressure is exerted manually on the flap 30, when the substance is being dispensed, due to the elastic deformation of the side walls of the grooved portion 16.

The elements that make up the dispensing and mixing device 10, such as the functional portion 12, the handle 14, the grooved portion 16, the lid 18, the first side wall 22, the second side wall 24, the restraining means 26, the hinge 28 and the flap 30 can be formed by using any suitable elastically deformable material. Preferably, the elastically deformable material is a polymeric resin and, even more preferably, a recyclable polymeric resin, such as for example polypropylene (PP), polyethylene (PE), polycarbonate (PC), polyethylene terephthalate (PET), polystyrene (PS), high-impact polystyrene (HIPS), acrylonitrile-butadiene-styrene (ABS), etc., or a biodegradable and/or compostable polymeric material, such as for example a polylactic-acid based resin (PLA), or combinations of different resins.

Moreover, in the design phase, the choice of the thickness of the elements that make up the dispensing and mixing device 10 is controlled, on the basis of the type of material, so as to guarantee the lifting of the flap 30, through the elastic deformation of the first side wall 22 and of the second side wall 24, by exerting a pressure, preferably with the fingers.

It is evident that, eventually, the elements that form the dispensing and mixing device 10 can be formed with a single material or with a combination of different materials and, for example, the elements that are subject to elastic deformation during their use can be made up of a more easily deformable material, that is, one having a smaller elastic module than the other elements.

In addition, depending on the use of the dispensing and mixing device 10, the polymeric resins can be materials adapted to come into contact with food products and/or for medical uses as required by the usage standards.

The processes for forming the dispensing and mixing device 10 and its components can be the conventional ones for transforming thermoplastic polymeric resins such as, for example, injection moulding or thermoforming. In the most preferred embodiment, the forming of the elements of the dispensing and mixing device 10 in a single piece, such as the functional portion 12, the handle 14, the grooved portion 16, the lid 18, the first side wall 22, the second side wall 24, the restraining means 26, the hinge 28 and a flap 30, makes it advantageous to have the forming of the dispensing and mixing device 10 in a single phase, such as for example injection moulding. In other words, it is possible to form the dispensing and mixing device 10 in a single moulding step and, moreover, it is possible to provide a plurality of impressions in the shaping-mould to produce with a single moulding step a plurality of dispensing and mixing devices 10, with evident advantages from the point of view of costs of production preferably on a large scale.

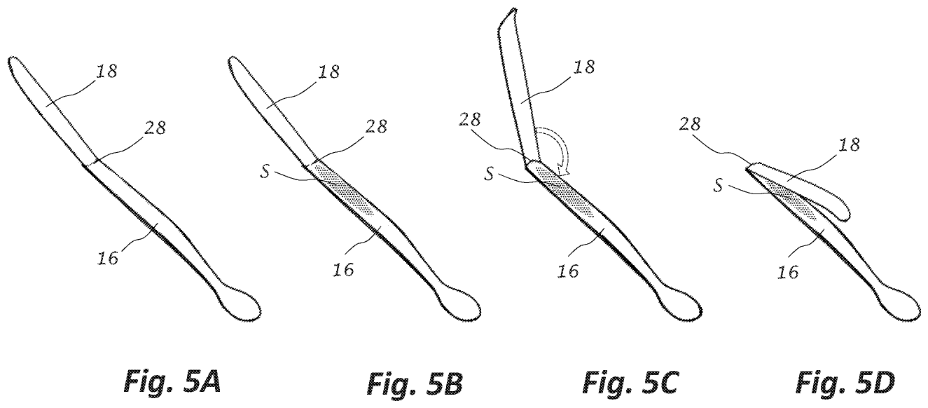

Referring to FIGS. 5A to 5D, the step-by-step phases of assembling the dispensing and mixing device 10 are now shown through schematic illustrations. First of all, the dispensing and mixing device 10 is in an open condition in which the lid 18 does not engage the upper opening of the grooved portion 16 (see FIG. 5A).

Subsequently, a quantity of substance is placed in the grooved portion 16 of the handle 14 (see FIG. 5B, in which the substance is shown as a dotted area indicated with a letter “S”). Advantageously, the positioning of the substance in this phase is easy because the upper opening of the grooved portion 16 is relatively large, that is, easily accessible.

The lid 18 is then rotated around the hinge 28 (see FIG. 50, in which the rotation is indicated by the thick broken arrow, and FIG. 5D) until it engages the upper opening of the grooved portion 16 as shown in FIG. 1, in which the dispensing and mixing device 10 is in its assembled condition and the lid 18 is fastened to the grooved portion 16 by the interference-fit restraining means 26.

Finally, the dispensing and mixing device 10, once assembled, can be inserted in a suitable package, such as an envelope, a box or a blister pack, so as to ensure its proper condition while maintaining the dispensing and mixing device 10, and the substance contained in it, safe from contamination with extraneous agents, moisture, etc. It is also possible to provide for the use of a removable protective film, such as one made of shrink-wrap material. This protective film wraps the dispensing and mixing device 10 and maintains in place the flap 30, in contact with the inside wall of the grooved portion 16, so as to prevent the opening of the cavity 20 if a pressure is accidentally applied on the first side wall 22 and on the second side wall 24 before using the dispensing and mixing device 10.

It is evident that different modifications of the dispensing and mixing device 10 of the present invention are possible without departing from the scope of patent protection as defined in claim 1.

For example, in the foregoing description, the lid 18 is connected to the grooved portion 16 of the handle 14 through the hinge 28, although other interference-fit restraining means 26 can be provided in place of the hinge 28, so that the lid 18 and the grooved portion 16 are formed separately and are fastened to each other later through the interference-fit restraining means 26 during the assembling phase.

Alternatively, a dispensing and mixing device 10 can be provided in which the lid 18 is connected to the upper edge of one of the side walls, the first side wall 22 or the second side wall 24, by means of at least one hinge 28 and is fastened to the other side wall through interference-fit restraining means 26.

Moreover, in the foregoing description, the lid 18 is adapted to mechanically engage the grooved portion 16 through two restraining means 26 formed on the first side wall 22 and on the second side wall 24, however it is possible to provide further restraining means arranged in the middle of the cavity 20 to further guarantee the fastening of the lid 18 to the grooved portion 16.

Moreover, a dispensing and mixing device 10 can be provided in which, when the cavity 20 is closed, the free end of the flap 30 faces the opposite direction with respect to the functional portion 12, or alternatively it faces perpendicular to the bottom of the grooved portion 16.

Eventually, it is possible to provide a thickness of the flap 30 smaller than the thickness of the lid 18, to which it is connected, so as to facilitate the elastic deformation of the flap 30. Alternatively, the thickness of the flap 30 can be variable and, preferably, decreasing toward the free end of the flap 30, so as to facilitate the elastic deformation of the same.

Moreover, it is possible to provide a dispensing and mixing device 10 in which on the bottom of the grooved portion 16, in the position corresponding with the flap 30, is formed a protrusion adapted to abut against the inner surface of the flap 30, inside the cavity 20, when the flap is not urged, that is, when the cavity 20 is closed. In this manner, the projection prevents the lowering of the flap 30 when the flap is urged, that is, it eases the lifting of the flap 30 when it is urged.

Moreover, in the foregoing description, the lid 18 is designed to fittingly engage a part of the grooved portion 16, however it is possible to provide a dispensing and mixing device 10 in which the lid completely engages the upper opening of the grooved portion 16.

Alternatively, it is possible to provide a dispensing and mixing device 10 in which the distance between the flap 30 and the functional portion 12 is adjusted on the basis of the depth to which, for example, the functional portion 12 is to be submerged to obtain the mixing of the substance in a liquid.

Moreover, it is possible to provide so that the elements that make up the dispensing and mixing device 10 can each be made of a different material with respect of the ones of the other elements. For example, it is possible to design the lid 18 to be made with a transparent material so as to allow the inspection of the cavity 20. Advantageously, with this configuration, it is possible to provide on the lid 18 a graduated scale adapted to measure the volume, or the quantity, of substance contained in the cavity 20; in other words, it is possible to measure the quantity of substance that has been dispensed.

In addition, in the foregoing description, the functional portion 12, the handle 14, the grooved portion 16, the lid 18 and the flap 30 are formed integrally using injection moulding or thermoforming processes, however it is possible to provide elements that are formed separately and that are fastened to each other later by heat-welding processes, before proceeding to the assembling phase previously described with reference to FIGS. 5A and 5D.

Hence, it should be evident that it is possible to use, separately or in combination, one or more moulding processes and/or materials to form the elements that make up the dispensing and mixing device 10.

Moreover, while the embodiment described here refers to the use of the dispensing and mixing device 10 for an alimentary product, such as sugar, it should be understood that the present invention can be used for any type of solid content in powder or granulated form, including food products, such as for example salt, condiments, etc., or medicinal drugs, such as pharmaceutical compounds or compositions.

Moreover, while the embodiment described above refers to a dispensing and mixing device 10 having a functional portion 12 shaped like a spoon, however the functional portion 12 can have any suitable shape, such as a fork, rod, spatula, etc. For example, the dispensing and mixing device 10 can dispense a condiment and the functional portion 12, made in the shape of a spatula, will be used to spread the condiment on the surface of a solid food product.

Moreover, while the embodiment described above refers to a dispensing and mixing device 10 having the flap 30 positioned next to the first end of the handle 14, connected in turn to the functional portion 12, it is however possible to provide so that the flap 30 of the lid 18 is formed next to the second end of the handle 14.

Finally, while the embodiment described above refers to a dispensing and mixing device 10 having a functional portion 12, it is possible to provide a dispensing and mixing device 10 provided with two functional portions 12 formed, for example, on each of the two ends of the handle 14.

From the foregoing description it is evident that important results have been achieved, overcoming the drawbacks of the prior art, making it possible to manufacture a dispensing and mixing device 10, preferably for alimentary or pharmaceutical use, that makes it possible to control the quantity of substance administered, that guarantees during its assembling the maintenance of the characteristics of the substance contained therein and that, finally, is simple to manufacture.

In fact, the dispensing and mixing device 10 is formed so as to provide a cavity 20 for containing the substance to be supplied, that can be opened or closed in an effective and intuitive manner by modulating the pressure exercised by the fingers on the first side wall 22 and on the second side wall 24 so as to urge the lifting or lowering of the flap 30. Specifically, the position of the flap 30 with respect to the extension of the handle 14 is properly selected so as not to interfere with the normal use of the dispensing and mixing device 10, making it possible, in an easy and intuitive manner, to urge the lifting of the flap 30 to deliver the substance and then mix it and/or spread it in accordance with the normal use of the dispensing and mixing device 10. The moulding of the flap 30 preferably in the proximity of the functional portion 12 prevents, advantageously, an undesirable dispersion of the substance outside, for example, of a cup during the use of the dispensing and mixing device 10.

Consequently, a user can control the quantity of substance that is delivered by the dispensing and mixing device 10 and, if the lid 18 is transparent, it is also possible to verify, or measure, the quantity of substance delivered.

Moreover, the specific configuration of the dispensing and mixing device 10 makes it possible, using the interference-fit restraining elements 26 and the hinge 28, to close the cavity 20 without using heat-welding processes and, therefore, in the assembling phase the characteristics of the substance contained therein are not altered.

Finally, the elements that make up the dispensing and mixing device 10 are easily assembled and can be formed in a simple manner using conventional processes. Specifically, in the most preferred embodiment, the moulding of the elements of the dispensing and mixing device 10 in a single piece, such as the functional portion 12, the handle 14, the grooved portion 16, the lid 18, the first aside wall 22, the second side wall 24, the restraining means 26, the hinge 28 and the flap 30, simplifies the subsequent steps of handling and assembling, preferably made in an automatic mode, for filling the cavity 20 with the substance to be administered and/or further steps of handling and/or packing. In addition, in the case in which a plurality of dispensing and mixing devices 10 are made in a single forming process, connected to each other through moulding-sprues, subsequent phases can be made more effective, preferably made in an automatic mode, for handling the dispensing and mixing devices 10 and filling the respective cavities 20 before they are separated from the moulding-sprues.

Naturally, the materials and equipment used for implementing the present invention, as well as the shape and dimensions of the individual components, may be the most adapted for the specific requirements.

1. A dispensing and mixing device comprising at least a functional portion, a handle that defines a cavity containing a substance adapted to be dispensed by said dispensing and mixing device by means of the opening of a flap
wherein
said handle comprises a grooved portion and a lid adapted to overlap each other and mutually engage mechanically to operatively define said cavity closed, and
said flap is elastically deformable and is also adapted to alternatively open said cavity when urged and to close said cavity when not urged.

2. The dispensing and mixing device according to claim 1, wherein said flap is formed on said lid.

3. The dispensing and mixing device according to claim 2, wherein said flap is formed inclined with respect to said lid from which it extends toward the bottom of said grooved portion.

4. The dispensing and mixing device according to claim 1, wherein said lid and said grooved portion are operatively connected to each other through at least a hinge.

5. The dispensing and mixing device according to claim 4, wherein said grooved portion, said lid and said hinge are formed in a single piece.

6. The dispensing and mixing device according to claim 1, wherein said flap is urged by means of a pressure that causes an elastic deformation of at least one of a first side wall and a second side wall of said grooved portion that are in contact with said flap.

7. The dispensing and mixing device according to claim 6, wherein said pressure is exerted on said flap through at least one of said first side wall and said second side wall whose elastic deformation causes the elastic deformation of said flap by means of contact.

8. The dispending and mixing device according to claim 6, wherein said first side wall and said second side wall are symmetric with respect to a longitudinal plane of said handle and are formed at least partially converging toward the bottom of said grooved portion.

9. The dispensing and mixing device according to claim 1, wherein said grooved portion comprises a protrusion adapted to abut against the inner surface of the flap, inside the cavity, when the flap is not urged.

10. The dispensing and mixing device according to claim 1, wherein said flap is formed facing toward the functional portion.

11. The dispensing and mixing device according to claim 1, wherein said flap is formed near said functional portion.

12. The dispensing and mixing device according to claim 1, wherein said flap has a free peripheral edge which is in a contact relationship with the internal surface of said grooved portion when it is not urged.

13. The dispensing and mixing device according to claim 1, wherein said lid and said grooved portion are operatively fastened to each other by means of interference-fit restraining means.

14. The dispensing and mixing device according to claim 1, made of at least a recyclable thermoplastic resin.

15. The dispensing and mixing device according to claim 1, made of at least a biodegradable thermoplastic resin.

16. The dispensing and mixing device according to claim 1, wherein said at least a functional portion is shaped in a shape chosen from the group comprising spoon, fork, knife, rod and spatula.

17. A process for assembling a dispensing and mixing device according to claim 1 comprising the steps of:
a) placing said substance in said grooved portion of said handle,
b) closing the upper opening of said grooved portion with said lid defining said cavity containing said substance.

18. The process for assembling a dispensing and mixing device according to claim 17 wherein in said step b) said grooved portion is closed by said lid through the rotation of the latter around a hinge that connects said grooved portion to said lid.

19. The process for assembling a dispensing and mixing device according to claim 17 wherein after said step b) it comprises the step of:
c) fastening said lid to said grooved portion by means of restraining means.

20. A method comprising utilizing a dispensing and mixing device according to claim 1 to contain food or pharmaceutic products.

21. A kit for alimentary or pharmaceutical use comprising a dispensing and mixing device according to claim 1.
